(19) United States
(12) Patent Application Publication
(10) Pub. No.: US 2026/0181631 A1
(43) Pub. Date: Jun. 25, 2026

(54) USER EQUIPMENT BEHAVIOR DURING DOWNLINK SCHEDULING GAPS

(71) Applicant: QUALCOMM Incorporated, San Diego, CA (US)

(72) Inventors: Diana MAAMARI, San Diego, CA (US); Ahmed Attia ABOTABL, San Diego, CA (US); Muhammad Sayed Khairy ABDELGHAFFAR, San Jose, CA (US); Gabi SARKIS, San Diego, CA (US)

(21) Appl. No.: 19/000,533

(22) Filed: Dec. 23, 2024

(51) Int. Cl. H04W 72/1273; H04L 5/14

(52) U.S. Cl. CPC H04W 72/1273; H04L 5/14

(57) ABSTRACT

Methods, systems, and devices for wireless communications are described. A user equipment (UE) may receive first configuration information indicating a first peak throughput rate associated with a first scheduling mode and a second configuration indication a second peak throughput rate less than the first peak throughput rate associated with a second scheduling mode. The second configuration information may indicate a quantity of gap transmission time intervals (TTIs) between shared data channel transmissions. The UE may receive a control message that schedules a shared data channel transmission during a first TTI in accordance with the second scheduling mode and may monitor the quantity of gap TTIs according to a monitoring configuration. The monitoring configuration may indicate whether to monitor a downlink control channel during the quantity of gap TTIs between shared data channel transmissions.

### FIELD OF TECHNOLOGY

The present disclosure relates to wireless communications, including user equipment (UE) behavior during downlink scheduling gaps.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first configuration information indicating a first peak throughput rate associated with a first scheduling mode for the UE and a first processing timeline, receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions, receiving a control message that schedules a shared data channel transmission during a first TTI in accordance with the second scheduling mode, and monitoring the quantity of gap TTIs following the shared data channel transmission according to a monitoring configuration, where the monitoring configuration indicates whether to monitor a downlink control channel during the quantity of gap TTIs between shared data channel transmissions.

A UE for wireless communications is described. The UE may include one or more memories storing processor executable code, and one or more processors coupled with the one or more memories. The one or more processors may individually or collectively be operable to execute the code to cause the UE to receive first configuration information indicating a first peak throughput rate associated with a first scheduling mode for the UE and a first processing timeline, receive second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap TTIs between shared data channel transmissions, receive a control message that schedules a shared data channel transmission during a first TTI in accordance with the second scheduling mode, and monitor the quantity of gap TTIs following the shared data channel transmission according to a monitoring configuration, where the monitoring configuration indicates whether to monitor a downlink control channel during the quantity of gap TTIs between shared data channel transmissions.

Another UE for wireless communications is described. The UE may include means for receiving first configuration information indicating a first peak throughput rate associated with a first scheduling mode for the UE and a first processing timeline, means for receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap TTIs between shared data channel transmissions, means for receiving a control message that schedules a shared data channel transmission during a first TTI in accordance with the second scheduling mode, and means for monitoring the quantity of gap TTIs following the shared data channel transmission according to a monitoring configuration, where the monitoring configuration indicates whether to monitor a downlink control channel during the quantity of gap TTIs between shared data channel transmissions.

A non-transitory computer-readable medium storing code for wireless communications is described. The code may include instructions executable by one or more processors to receive first configuration information indicating a first peak throughput rate associated with a first scheduling mode for the UE and a first processing timeline, receive second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap TTIs between shared data channel transmissions, receive a control message that schedules a shared data channel transmission during a first TTI in accordance with the second scheduling mode, and monitor the quantity of gap TTIs following the shared data channel transmission according to a monitoring configuration, where the monitoring configuration indicates whether to monitor a downlink control channel during the quantity of gap TTIs between shared data channel transmissions.

In some examples of the method, UEs, and non-transitory computer-readable medium described herein, the quantity of gap TTIs following the shared data channel transmission includes a subband full duplex (SBFD) TTI.

In some examples of the method, UEs, and non-transitory computer-readable medium described herein, the monitoring configuration indicates to skip monitoring of one or more downlink subbands of the SBFD TTI and enables transmission of one or more uplink messages via one or more uplink subbands of the SBFD TTI.

In some examples of the method, UEs, and non-transitory computer-readable medium described herein, the monitoring configuration indicates to monitor one or more downlink subbands of the SBFD TTI and the method, apparatuses, and non-transitory computer-readable medium may include further operations, features, means, or instructions for receiving, via the one or more downlink subbands of the SBFD TTI, a second control message indicating scheduling information, where the scheduling information schedules downlink data on one or more TTIs that occur after a last symbol of the quantity of gap TTIs following the shared data channel transmission.

In some examples of the method, UEs, and non-transitory computer-readable medium described herein, a SBFD collision rule indicates to prioritize one of a downlink subband or an uplink subband of one or more SBFD TTIs that occur within the quantity of gap TTIs following the shared data channel transmission.

In some examples of the method, UEs, and non-transitory computer-readable medium described herein, the monitoring configuration indicates to refrain from monitoring one or more downlink subbands of one or more SBFD TTIs that occur within the quantity of gap TTIs following the shared data channel transmission and to skip transmission during one or more uplink subbands of the one or more SBFD TTIs that occur within the quantity of gap TTIs following the shared data channel transmission.

In some examples of the method, UEs, and non-transitory computer-readable medium described herein, the quantity of gap TTIs following the shared data channel transmission includes a second TTI including one or more flexible symbols and the monitoring configuration indicates that conversion of the one or more flexible symbols of the second TTI to downlink symbols may be associated with an error condition.

In some examples of the method, UEs, and non-transitory computer-readable medium described herein, the quantity of gap TTIs following the shared data channel transmission includes a second TTI including one or more flexible symbols and the monitoring configuration indicates that transmission and reception during the second TTI may be invalid.

In some examples of the method, UEs, and non-transitory computer-readable medium described herein, the quantity of gap TTIs following the shared data channel transmission includes a second TTI including one or more flexible symbols and the monitoring configuration indicates that the one or more flexible symbols of the second TTI may be uplink symbols.

In some examples of the method, UEs, and non-transitory computer-readable medium described herein, the quantity of gap TTIs following the shared data channel transmission includes a downlink TTI and the monitoring configuration indicates to refrain from monitoring the downlink control channel during the downlink TTI.

In some examples of the method, UEs, and non-transitory computer-readable medium described herein, the quantity of gap TTIs following the shared data channel transmission includes a downlink TTI and the method, apparatuses, and non-transitory computer-readable medium may include further operations, features, means, or instructions for receiving, during the downlink TTI, a second control message indicating scheduling information, where the scheduling information schedules downlink data on one or more TTIs that occur after a last symbol of the quantity of gap TTIs following the shared data channel transmission.

Some examples of the method, UEs, and non-transitory computer-readable medium described herein may further include operations, features, means, or instructions for receiving control signaling indicating the monitoring configuration.

In some examples of the method, UEs, and non-transitory computer-readable medium described herein, the control signaling indicating the monitoring configuration includes at least one of the control message, radio resource control (RRC) signaling, group common downlink control information (DCI), or a combination thereof.

In some examples of the method, UEs, and non-transitory computer-readable medium described herein, the control signaling indicates an index value corresponding to the monitoring configuration from a set of multiple index values, each index value of the set of multiple index values indicating a respective monitoring configuration of a set of multiple monitoring configurations.

Some examples of the method, UEs, and non-transitory computer-readable medium described herein may further include operations, features, means, or instructions for transmitting capability information indicating a capability of the UE to support monitoring of the downlink control channel during the quantity of gap TTIs following the shared data channel transmission, where the monitoring configuration may be based on the capability information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment (UE) behavior during downlink scheduling gaps in accordance with one or more aspects of the present disclosure.

FIG. 2 shows an example of a timing diagram that supports UE behavior during downlink scheduling gaps in accordance with one or more aspects of the present disclosure.

FIG. 3 shows an example of a process flow that supports UE behavior during downlink scheduling gaps in accordance with one or more aspects of the present disclosure.

FIGS. 4 and 5 show block diagrams of devices that support UE behavior during downlink scheduling gaps in accordance with one or more aspects of the present disclosure.

FIG. 6 shows a block diagram of a communications manager that supports UE behavior during downlink scheduling gaps in accordance with one or more aspects of the present disclosure.

FIG. 7 shows a diagram of a system including a device that supports UE behavior during downlink scheduling gaps in accordance with one or more aspects of the present disclosure.

FIG. 8 shows a flowchart illustrating methods that support UE behavior during downlink scheduling gaps in accordance with one or more aspects of the present disclosure.

### DETAILED DESCRIPTION

In some wireless communications systems, a user equipment (UE) (e.g., a half duplex UE) may be configured to receive downlink data transmissions at a reduced peak throughput. For example, a network node in communication with the UE may indicate to the UE that downlink scheduling of data transmissions is in accordance with a reduced peak throughput or that a number of slots following a first slot in which a downlink data transmission is received are gap slots not to be scheduled with downlink data transmissions. During the gap slots, the UE may enter a relatively high power state to process the downlink data transmission received. In some cases, depending on a capability of the UE, the UE may be capable of transmitting uplink messages during the gap slots or monitoring a control channel for downlink control messages. However, the UE and the network node may fail to coordinate on which UE behaviors are configured or allowed for the gap slots, resulting in wasted energy or processing power at the UE, at the network node, or both.

According to the examples described herein, the UE may be configured with one or more behaviors (e.g., may be configured to either perform or refrain from performing one or more operations) during gap slots following a downlink data transmission. For example, in the case of a subband full duplex (SBFD) slot that occurs during the gap, the UE may be configured to monitor a physical downlink control channel (PDCCH), may be configured to transmit uplink messages, or may not be configured to monitor the PDCCH nor transmit uplink messages. In some implementations, the UE behavior may be configured via radio resource (RRC) signaling from a network node, or the network node may dynamically indicate the UE behavior via a scheduling downlink control information (DCI) message or a group common DCI message. In some implementations, the UE may signal its capabilities for gap slots to the network node, and the configured UE behavior may be based on the UE capabilities.

Aspects of the disclosure are initially described in the context of wireless communications systems. timing diagrams and process flows. Aspects of the disclosure are further illustrated by and described with reference to apparatus diagrams, system diagrams, and flowcharts that relate to UE behavior during downlink scheduling gaps.

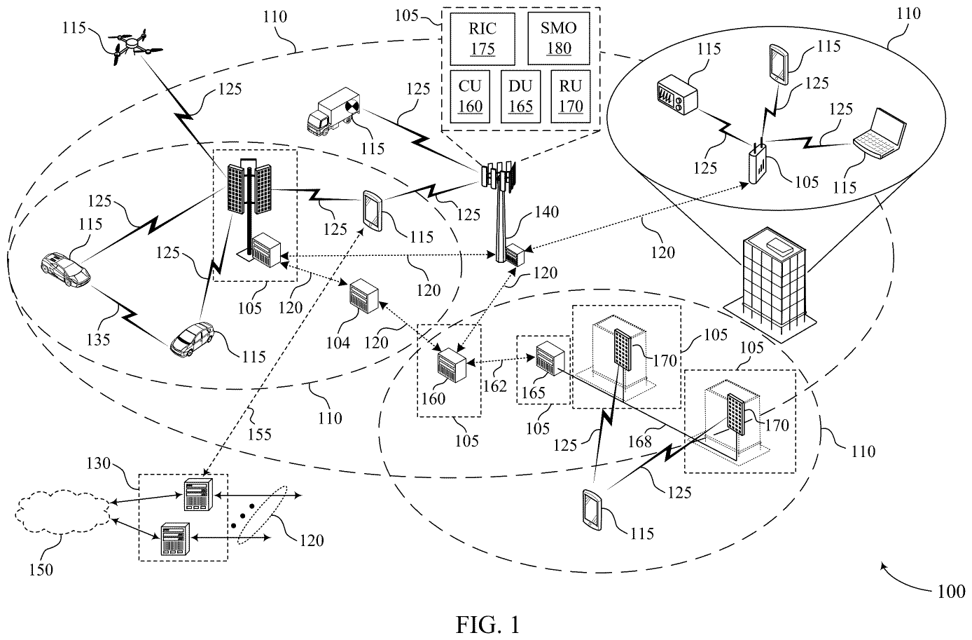

FIG. 1 shows an example of a wireless communications system 100 that supports UE behavior during downlink scheduling gaps in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support UE behavior during downlink scheduling gaps as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Peak rate may be defined by Equation 1.

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot R \frac{{N}_{PRB}^{BW ( j ) , µ} \cdot 12}{{Z}^{( j )} {T}_{S}^{µ}} {( 1 - {OH}^{( j )} )}_{max} ) \qquad ( 1 )$$

In Equation 1,

$${N}_{P R B}^{B W ( j ) , μ}$$

may be a bandwidth (e.g., quantity of physical resource blocks (PRBs)).

$${v}_{L a y e r s}^{( j )}$$

may be a quantity of layers.

$${Q}_{m}^{( j )}$$

may be a maximum supported modulation order. f^{(j)} may be a first scaling factor. z^{(j)} may be a second scaling factor. In some examples, the UE 115 may be configured with efficient scheduling (e.g., which may be indicated via one or more parameters of Equation 1). For example, the network node 105 may indicate efficient scheduling (e.g., reduced peak rate, efficient scheduling mode of the UE 115) by indicating a scaling factor z^{(j)} that is less than one, by indicating a processing timeline relaxation (e.g., feedback being relaxed), by indicating discontinuous reception slots between PDSCH transmission, or a combination thereof. In some examples, the efficient scheduling mode may indicate that a value of an offset N1 is relaxed, and as such a value of an offset K1 is relaxed. The offset N1 may be defined as a minimum time duration after decoding PDCCH by the UE 115 in which the UE 115 is ready to receive a PDSCH transmission. N1 may be determined by UE capability. The offset K1 may be defined as a slot offset between a downlink slot where data is scheduled and an uplink slot where corresponding feedback (e.g., ACK/NACK) for that data is to be received on a PUCCH from the UE 115.

Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, a UE 115 (e.g., a half duplex UE 115) may be configured to receive downlink data transmissions at a reduced peak throughput. For example, a network node 105 in communication with the UE 115 may indicate to the UE 115 that downlink scheduling of data transmissions is in accordance with a reduced peak throughput or that a number of slots following a first slot in which a downlink data transmission is received are gap slots not to be scheduled with downlink data transmissions. During the gap slots, the UE 115 may enter a relatively high power state to process the downlink data transmission received. In some cases, depending on a capability of the UE 115, the UE 115 may be capable of transmitting uplink messages during the gap slots or monitoring a control channel for downlink control messages. However, the UE 115 and the network node 105 may fail to coordinate on which UE behaviors are configured or allowed for the gap slots, resulting in wasted energy or processing power at the UE 115, at the network node 105, or both.

According to the examples described herein, the UE 115 may be configured with one or more behaviors (e.g., may be configured to either perform or refrain from performing one or more operations) during gap slots following a downlink data transmission. For example, in the case of a SBFD slot that occurs during the gap, the UE 115 may be configured to monitor a physical downlink control channel PDCCH may be configured to transmit uplink messages, or may not be configured to monitor the PDCCH nor transmit uplink messages. In some implementations, the UE behavior may be configured via RRC signaling from a network node 105, or the network node may dynamically indicate the UE behavior via a scheduling DCI message or a group common DCI message. In some implementations, the UE 115 may signal its capabilities for gap slots to the network node 105, and the configured UE behavior may be based on the UE capabilities.

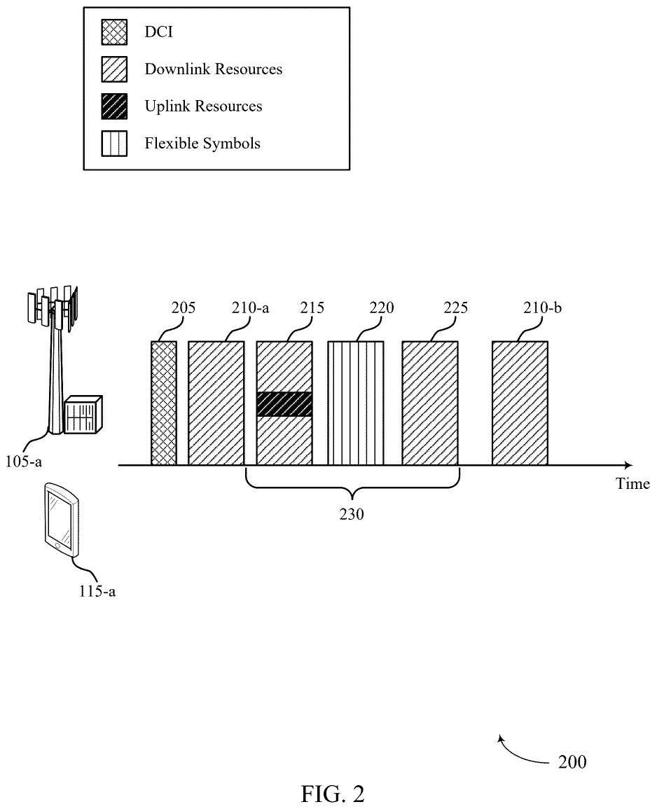

FIG. 2 shows an example of a timing diagram 200 that supports UE behavior during downlink scheduling gaps in accordance with one or more aspects of the present disclosure. The timing diagram 200 may implement or may be implemented by aspects of the wireless communications system 100. For example, the timing diagram 200 may include a UE 115-a and a network node 105-a, which may be examples of corresponding devices described herein.

In some examples, the UE 115-a may be configured to perform RF operations, baseband operations, or both. For high throughput and wideband scheduling, the UE 115-a may enter its highest power state. In new radio (NR) wireless communications systems, the UE 115-a may move its internal baseband clock/voltage to higher power state when the UE 115-a switches to wideband scheduling. This high-power mode of the UE 115-a involves higher clock frequency and generally higher supply voltage to support the higher clock frequency, leading to a quadratic increase in power consumption as well as leakage.

In some cases, a network node 105-a may inform the UE 115-a as to how long the UE 115-a will be scheduled with wideband scheduling such that the UE 115 may set its clock frequency and voltage as needed and not necessitate the highest setting corresponding to the wideband scheduling for longer than is needed. The UE 115-a may benefit from an indication that the UE 115-a will not be scheduled with sustained peak throughput. For example, the network node 105-a may guarantee the UE 115-a that there will be no scheduling of PDSCH transmissions following a wideband scheduling.

In some cases, the network node 105-a may guarantee (e.g., signal) to the UE 115-a that: maximum scheduled throughput may not exceed a limit; feedback timeline may be relaxed; if feedback occasion is kept the same as with narrowband scheduling, the broadband may be kept at low; and/or there will be gaps (e.g., scheduling gaps) between PDSCH transmissions.

In some examples, the UE 115-a may be configured for efficient downlink scheduling. PDSCH scheduling may be wideband but peak throughput may be reduced for the wideband scheduling by specifying that certain slots may not be scheduled and by specifying a relaxation in the feedback timeline. One or more predefined communication parameters or rules may indicate that the UE 115-a will not be scheduled with any PDSCH transmission after wideband transmissions and/or may indicate the relaxed feedback timeline. In an efficient scheduling mode, the UE 115-a may perform decoupling of RF and baseband power state, which may enable reduction in UE energy.

When downlink data is less than peak throughput, gaps may be guaranteed between PDSCH transmissions, and feedback timeline may be relaxed. Gaps may be defined as transmission time intervals (TTIs) (e.g., slots, symbols, subframes) where the UE 115-a expects no scheduling (e.g., may be similar to a time division multiplexing (TDM) duty cycle where during inactive states the UE 115-a is in RF microsleep but baseband is still running). Such gaps may be used by the UE 115-a to process the PDSCH transmission.

The UE 115-a may move RF to a high-power state but keep baseband in a lower-power state. Each PDSCH transmission may use a quantity Tbaseband slots (e.g., three slots) for baseband processing of the wideband PDSCH transmission at the lower clock. A set of gap slots 230 following a PDSCH transmission 210-a may include RF microsleep slots or gaps where no downlink PDSCH scheduling is expected since the UE 115-a is busy with baseband processing the PDSCH transmission 210-a at low power state.

In some examples, the gap slots 230 may include an SBFD slot 215. New time-domain collision rules between conflicting transmission and reception may be resolved according to predefined communication parameters or rules to account for time domain collision between conflicting transmission and reception in the SBFD slot 215. A baseline (e.g., default) configuration of the SBFD slot 215 may indicate that the UE 115 treats the SBFD slot 215 as flexible symbols where the UE 115-a determines traffic direction based on dynamic scheduling (e.g., UE 115-a monitors PDCCH candidates) or semi-static signaling. Additionally, or alternatively, a default behavior of direction may be indicated by RRC parameter where the UE 115-a is semi-statically indicated with downlink or uplink (e.g., via new RRC signaling or reusing existing signaling such as a TDD-ULDL-dedicated field).

In some examples, a time-domain collision between conflicting transmission and reception in SBFD symbols may occur. For example, at least one OFDM symbol overlap of uplink transmission and downlink reception may occur. Additionally, or alternatively, a time-domain collision may occur based on a lack of a sufficient timeline for reception and transmission switching (e.g., an overlap based on physical time). In some examples, one or more design principles may be implemented for collision handling on the SBFD slot 215. For example, the UE may expect to not be configured by higher layers for uplink transmission and downlink reception. In some examples, semi-static uplink and/or downlink signaling (e.g., (e.g., sounding reference signals in downlink) may not be allowed in symbols having conflicting directions.

If the UE 115-a is a half-duplex UE (e.g., and the UE 115-a is aware of the SBFD slot 215), then whether to transmit or receive during the SBFD slot 215 may be specified (e.g., preconfigured, indicated via configuration signaling). In some examples, the UE 115-a may be preconfigured with a first set of rules for collisions on the SBFD slot. In some examples, the half duplex UE 115-a may be configured to communicate semi-statically with the network node 105. In such examples, the UE 115-a may be configured with a second set of rules for collisions on the SBFD slot. For example, the UE 115-a may be configured to prioritize uplink (e.g., due to coverage and latency considerations) except for PDCCH monitoring opportunities and tracking reference signals being prioritized over uplink. Additionally, or alternatively, a priority rule (e.g., indication of which signaling is relatively lower priority and relatively higher priority) may be configured by the network node 105 to resolve collisions.

In some examples, the UE 115-a may receive a control message 205 (e.g., a DCI message) that schedules a PDSCH transmission 210-a (e.g., a data message). The UE 115-a may be configured for an efficient scheduling mode, and a number of gap slots 230 (e.g., transmission time intervals (TTIs)) may follow the PDSCH transmission 210-a. The UE 115-a may determine that the UE 115-a is not to be scheduled with PDSCH during the gap slots (e.g., otherwise a demapper or decoder of the UE 115-a may be overloaded). However, in some cases, the UE 115-a may be capable of performing one or more operations during gap slots that are special slots (e.g., slots with one or more flexible symbols) and SBFD slots. In some examples, the gap slots may include an SBFD slot 215 and may include downlink subbands and uplink subbands. Gap slots 230 (e.g., scheduling restricted slots) which coincide with SBFD slots may be unable to be scheduled with any downlink transmission, but the UE 115-a may use the uplink subbands of the SBFD slots for uplink transmissions. In some other cases, the gap slots may include a downlink slot. Though the downlink slot is disallowed from being scheduled with PDSCH, some configurations may support the UE 115-a monitoring PDCCH for control messages (e.g., DCI) which schedule on the PDSCH.

In accordance with examples described herein, the UE 115-a may be configured (e.g., according to predefined parameters or rules or via signaling from the network node 105) with a UE behavior configuration (e.g., a monitoring configuration) for downlink scheduling gaps. For example, the UE behavior configuration may differentiate the UE behavior during subsequent gap slots 230 following the PDSCH in accordance with a reduced peak throughput (e.g., reduced data rate). In an example, the UE 115-a may receive first configuration information for downlink scheduling in accordance with a first peak throughput and may receive second configuration information for downlink scheduling in accordance with a second (e.g., reduced) peak throughput less than the first peak throughput. The UE 115-a may determine that no subsequent PDSCH transmissions are scheduled during a number of gaps (e.g., a quantity of one or more gap slots 230) after the PDSCH transmission 210-a transmitted with the reduced peak throughput (e.g., while the UE 115-a operates in a scheduling mode associated with the second reduced peak throughput). Additionally, or alternatively, the UE 115-a may determine that feedback to the PDSCH transmission 210-a is according to a relaxed processing timeline (e.g., a relatively longer processing timeline than a default processing timeline) based on the PDSCH transmission 210-a being transmitted with the reduced peak throughput.

In some examples, the one or more gap slots 230 may include an SBFD slot 215 with one or more downlink subbands and one or more uplink subbands. The UE behavior configuration may indicate that the half duplex UE 115-a refrains from monitoring the PDCCH in the downlink subbands of the SBFD slot 215. Additionally, or alternatively, the network node 105 may not schedule PDSCH in the downlink subbands of the SBFD slot 215 during the one or more gap slots 230 (e.g., a quantity of gap slots) after the PDSCH transmission 210-a with the second reduced peak throughput. The UE behavior configuration may indicate that the UE 115-a may transmit uplink sounding reference signals, physical uplink shared channel transmissions, physical uplink control channel transmissions, or a combination thereof in the uplink subbands of the same SBFD slot 215 (e.g., that occurs within the one or more gap slots 230).

In some other implementations, the UE behavior configuration may indicate that the half duplex UE 115-a may monitor the PDCCH in valid PDCCH monitoring opportunities of the downlink subbands during the subsequent quantity of gap slots 230 following the PDSCH transmission with the second reduced peak throughput. A control message received during an SBFD slot 215 of the gap slots 230 may schedule a PDSCH transmission 210-b that occurs after the gap slots 230. For example, PDSCH transmissions that are scheduled by the PDCCH during the SBFD slot 215 may satisfy a threshold value with respect to an offset value K0. The offset value K0 may indicate an offset (e.g., minimum offset) between a last symbol of the control message and a first symbol of the scheduled PDSCH transmission. In some implementations, KG is configured to satisfy the following equation: K0>max(K0 min, remaining slots until an end of the number of gap slots).

Whether the half duplex UE 115-a prioritizes the downlink or the uplink direction in at least one or more of the orthogonal frequency division multiplexing (OFDM) symbols of PDCCH and uplink transmissions may be based on one or more SBFD collision rules (e.g., which may be defined irrespective of the presence of gap slots 230).

In some other implementations, the UE behavior configuration may indicate that the half duplex UE 115-a neither receives nor transmits during the downlink and uplink subbands of the SBFD slot 215 (e.g., that occurs within the one or more gap slots 230).

In some examples, the one or more gap slots 230 may include a special slot 220 with one or more flexible symbols. A flexible symbol may refer to a symbol that may be dynamically configured by the network node 105-a (e.g., via a slot form indicator (SFI) in DCI) to be either an uplink symbol or a downlink symbol. The UE behavior configuration may indicate that the UE 115-a is not expected to receive an SFI to convert flexible symbols (e.g., that occurs within the one or more gap slots 230) to downlink symbols but that the UE may still receive an SFI that converts flexible symbols to uplink symbols (e.g., that occurs within the one or more gap slots 230). For example, an SFI that converts flexible symbols to downlink symbols may be considered as an error condition. In some implementations, the UE behavior configuration may indicate that the special slot 220 with one or more flexible symbols may be invalid for transmission or reception, or both (e.g., that occurs within the one or more gap slots 230). In some implementations, the UE behavior configuration may indicate that flexible symbols may be uplink symbols by default during the one or more gap slots 230. According to the aforementioned techniques, the UE behavior configuration may allow for the special slot 220 during the gap slots 230 to be used for uplink as opposed to downlink communication (e.g., based on PDSCH scheduling being disallowed). Alternatively, or additionally, the network node 105 may determine a cross link interference impact and may disable communication on the special slot 220 altogether.

In some examples, the one or more gap slots 230 may include a downlink slot 225. In some implementations, the UE behavior configuration may indicate that the UE 115-a is not required to monitor the PDCCH in the one or more gap slots 230 (e.g., not required to monitor a quantity of gap slots) 230 after the PDSCH transmission 210-a with the reduced peak throughput. The network node 105 may refrain from transmitting PDCCH transmissions or PDSCH transmissions to the UE 115-a during the gap slots 230. In some other implementations, the UE behavior configuration may indicate that the UE 115-a is not scheduled with PDSCH transmissions in the subsequent number of gap slots 230 but that the UE 115-a still monitors the PDCCH. The number of gap slots 230 may be measured from a starting symbol after the wideband PDSCH transmission 210-a.

A control message received during a downlink slot 225 of the gap slots 230 may schedule a PDSCH transmission 210-b that occurs after the gap slots 230. For example, PDSCH transmissions that are scheduled by the PDCCH during the downlink slot 225 may satisfy a threshold value with respect to an offset value K0. The offset value K0 may indicate an offset (e.g., minimum offset) between a last symbol of the control message and a first symbol of the scheduled PDSCH transmission. In some implementations, K0 is configured to satisfy the following equation: K0>max(K0 min, remaining slots until an end of the number of gap slots). In an example, the UE 115-a may still monitor PDCCH within the one or more gap slots 230 but K0>max (min K0, remaining slots till end of Ngap) where a quantity of the gap slots 230 (e.g., Ngap) may be measured from a starting symbol that occurs after the PDSCH transmission 210-a (e.g., the Wideband PDSCH).

In some examples, the network node 105 may configure the UE behavior configuration (e.g., monitoring configuration) for downlink scheduling gaps (e.g., via RRC signaling transmitted from the network node 105 to the UE 115-a). In some examples, the UE behavior configuration may be according to one or more predefined parameters or rules for communication. In some implementations, the network node 105 may use one or more dynamic indications to change the UE behavior configuration on the gap slots 230. For example, a control message (e.g., a group common DCI or a scheduling DCI) that schedules the PDSCH transmission may indicate the UE behavior configuration to apply for the gap slots 230 (e.g., overriding the RRC configured or default UE behavior configuration). In some examples, the UE behavior configuration for downlink scheduling gaps may be based on UE capabilities.

In some examples, the UE behavior configuration may be according to an index value of a set of index values of a gap slot type that each correspond to a respective UE behavior configuration. For example, a first index value may indicate that the UE 115-a monitors PDCCH monitoring with K0 being greater than the gap length (e.g., a quantity of symbols or a quantity of slots of the gap 230). A second index value may indicate that the UE 115-a refrains from monitoring PDCCH and that the UE 115-a does not receive PDSCH transmissions or reference signals during the scheduling gap 230. A third index value may indicate that the scheduling gap 230 may be used by the UE 115-a for uplink transmissions (e.g., configured grant (CG) PUSCH, data-specific grouped (DG) PUSCH, SRS, other uplink transmissions). A fourth index value may indicate that the scheduling gap 230 cannot be used by the UE 115-a for uplink transmission. A fifth index value may indicate that uplink transmissions are prioritized in SBFD slots during the scheduling gap 230. In some implementations, the UE behavior configuration may be based on multiple of the index values being indicated or enabled (e.g., or a single index value may be indicated or enabled). The index values described herein are examples, and any other index values corresponding to other potential UE behavior configurations may be possible.

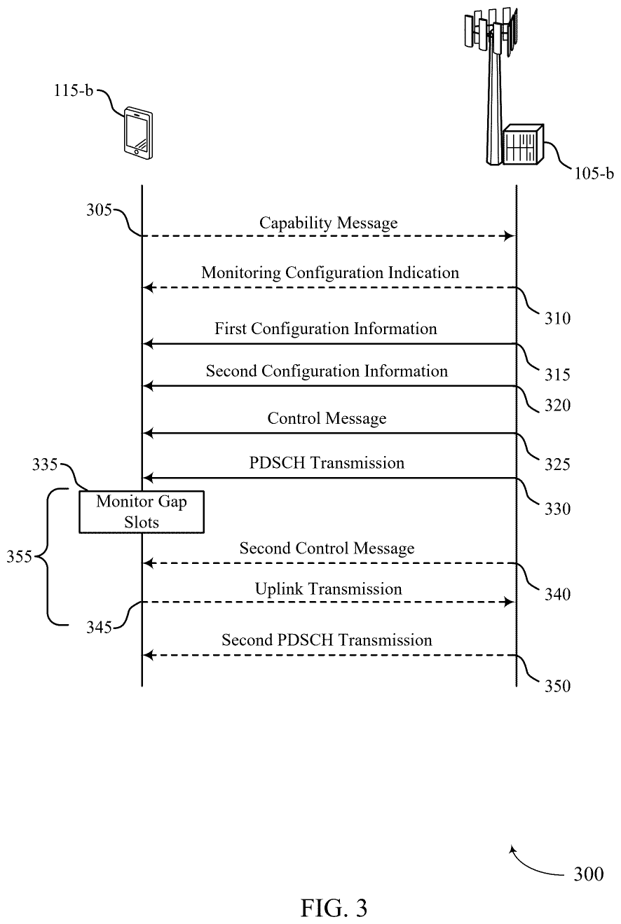

FIG. 3 shows an example of a process flow 300 that supports UE behavior during downlink scheduling gaps in accordance with one or more aspects of the present disclosure. The process flow 300 may implement or may be implemented by aspects of the wireless communications system 100 or the timing diagram 200. For example, the process flow 300 may include a UE 115-b and a network node 105-b, which may be examples of corresponding devices described herein.

At 305, the UE 115-b may transmit capability information indicating a capability of the UE 115-b to support monitoring of a PDCCH during a scheduling gap 355 (e.g., a quantity of gap TTIs) following the shared data channel transmission.

At 310, the UE 115-b may receive control signaling from the network node 105-b indicating a monitoring configuration (e.g., a PDCCH monitoring configuration, a UE behavior configuration) for the scheduling gap 355. The monitoring configuration may indicate whether to monitor the PDCCH during the scheduling gap 355 (e.g., the one or more gap slots 230) between PDSCH transmissions. Additionally, or alternatively, the monitoring configuration may indicate whether to transmit uplink messages during the scheduling gap 355 between PDSCH transmissions. In some other implementation, the monitoring configuration may be indicated via one or more predefined parameters or rules. In some implementations, the control signaling may indicate an index value corresponding to the monitoring configuration from a set of index values, where each index value indicates a respective monitoring configuration of a set of monitoring configurations. The control signaling may be RRC signaling, group common DCI, scheduling DCI, or a combination thereof.

At 315, the UE 115-b may receive first configuration information indicating a first peak throughput rate associated with a first scheduling mode (e.g., default scheduling mode) for the UE 115-b and a first processing timeline (e.g., feedback timeline for signaling feedback to a PDSCH transmission). At 320, the UE 115-b may receive second configuration information indicating a second peak throughput rate associated with a second scheduling mode (e.g., efficient scheduling mode) for the UE 115-b and a second processing timeline. The second peak throughput rate may be less than the first peak throughput rate (e.g., may be a reduced peak throughput rate) and the second processing timeline may be longer than the first processing timeline (e.g., may be a relatively relaxed feedback/processing timeline). The second configuration information may indicate a quantity of gap TTIs between shared data channel transmissions (e.g., the scheduling gap 355).

At 325, the UE 115-b may receive a control message (e.g., DCI message) that schedules a PDSCH transmission during a first TTI in accordance with the second scheduling mode (e.g., efficient scheduling mode), the second peak throughput rate, or both. At 330, the UE 115-b may receive the PDSCH transmission in accordance with the second peak throughput rate. The scheduling gap 355 may start after (e.g., immediately after) a last symbol of the PDSCH transmission at 330 and may have a duration equal to the configured number of gap TTIs according to the second scheduling mode (e.g., indicated by the second configuration information).

At 335, the UE 115-b may monitor the quantity of gap TTIs following the PDSCH transmission according to the monitoring configuration. At 340, the UE 115-b may monitor the PDCCH during at least a portion of the scheduling gap 355 and may receive a second control message (e.g., DCI) responsive to monitoring the PDCCH. The UE 115-b may receive the second control message via downlink subbands of an SBFD slot or during a downlink slot. The second control message may include scheduling information that schedules a second PDSCH transmission on one or more TTIs that occur after a last symbol of the scheduling gap 355.

At 345, the UE 115-b may transmit an uplink message (e.g., PDCCH message, PDSCH message) to the network node 105 during the scheduling gap 355. The UE 115-b may transmit the uplink message via uplink subbands of an SBFD slot or during an uplink slot. In some implementations, whether the UE 115-b monitors the PDCCH, transmits uplink messages, or both during a gap slot of the scheduling gap 355 may be based on a slot type of the gap slot. For example, the UE behavior configuration during the gap TTI may be based on whether the gap slot is an SBFD slot, a special slot with flexible symbols, a downlink slot, or an uplink slot.

At 350, the UE 115-b may receive a second PDSCH transmission. The UE 115-b may receive the second PDSCH transmission after a last symbol of the scheduling gap 355. The second PDSCH transmission may be scheduled by a control message that the UE 115-b receives during the scheduling gap 355 (e.g., at 340).

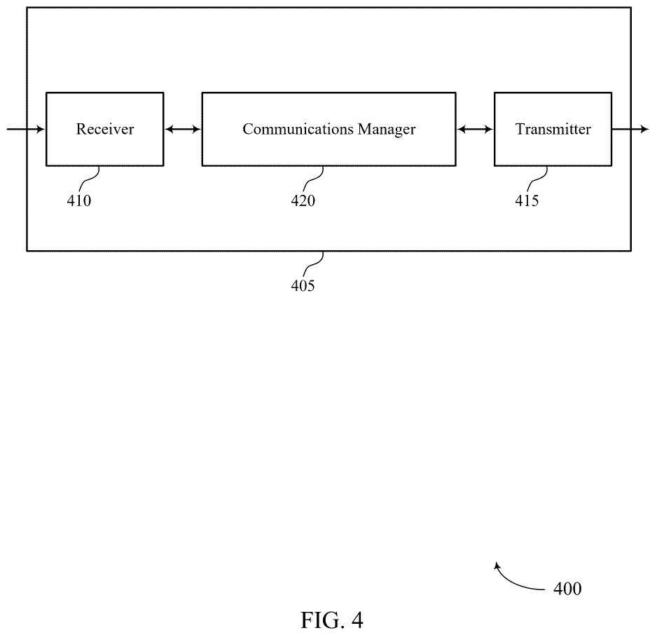

FIG. 4 shows a block diagram 400 of a device 405 that supports UE behavior during downlink scheduling gaps in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include one or more processors, memory coupled with the one or more processors, and instructions stored in the memory that are executable by the one or more processors to enable the one or more processors to perform the UE behavior during downlink scheduling gaps features discussed herein. Each of these components may be in communication with one another (e.g., via one or more buses).

The receiver 410 may provide a means for receiving information such as packets, user data, control information, or any combination thereof associated with various information channels (e.g., control channels, data channels, information channels related to UE behavior during downlink scheduling gaps). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to UE behavior during downlink scheduling gaps). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of UE behavior during downlink scheduling gaps as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first configuration information indicating a first peak throughput rate associated with a first scheduling mode for the UE and a first processing timeline. The communications manager 420 is capable of, configured to, or operable to support a means for receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions. The communications manager 420 is capable of, configured to, or operable to support a means for receiving a control message that schedules a shared data channel transmission during a first TTI in accordance with the second scheduling mode. The communications manager 420 is capable of, configured to, or operable to support a means for monitoring the quantity of gap TTIs following the shared data channel transmission according to a monitoring configuration, where the monitoring configuration indicates whether to monitor a downlink control channel during the quantity of gap TTIs between shared data channel transmissions.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for processing, reduced power consumption, and more efficient utilization of communication resources.

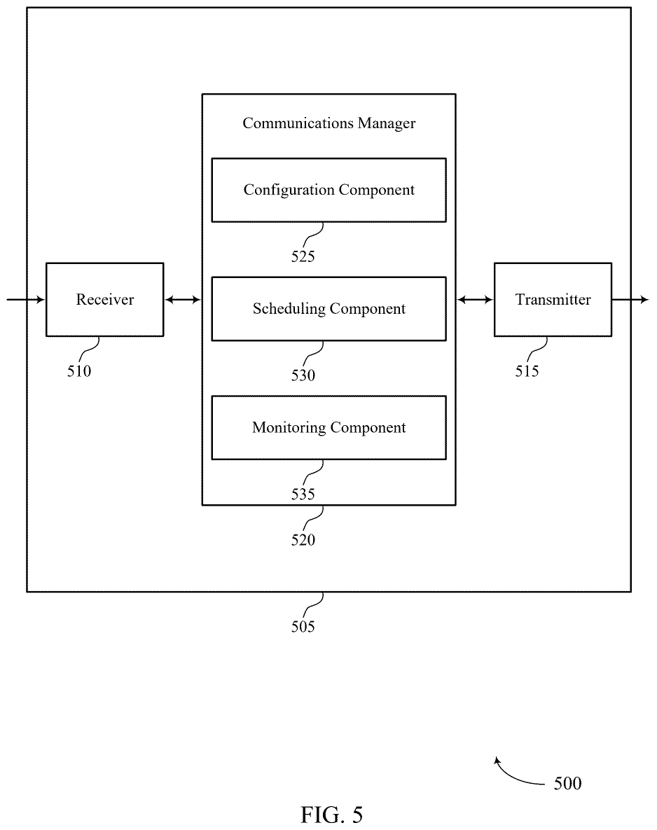

FIG. 5 shows a block diagram 500 of a device 505 that supports UE behavior during downlink scheduling gaps in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to UE behavior during downlink scheduling gaps). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE behavior during downlink scheduling gaps). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of UE behavior during downlink scheduling gaps as described herein. For example, the communications manager 520 may include a configuration component 525, a scheduling component 530, a monitoring component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receiving first configuration information indicating a first peak throughput rate associated with a first scheduling mode for the UE and a first processing timeline. The configuration component 525 is capable of, configured to, or operable to support a means for receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions. The scheduling component 530 is capable of, configured to, or operable to support a means for receiving a control message that schedules a shared data channel transmission during a first TTI in accordance with the second scheduling mode. The monitoring component 535 is capable of, configured to, or operable to support a means for monitoring the quantity of gap TTIs following the shared data channel transmission according to a monitoring configuration, where the monitoring configuration indicates whether to monitor a downlink control channel during the quantity of gap TTIs between shared data channel transmissions.

In some cases, the configuration component 525, the scheduling component 530, and the monitoring component 535 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 525, the scheduling component 530, and the monitoring component 535 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

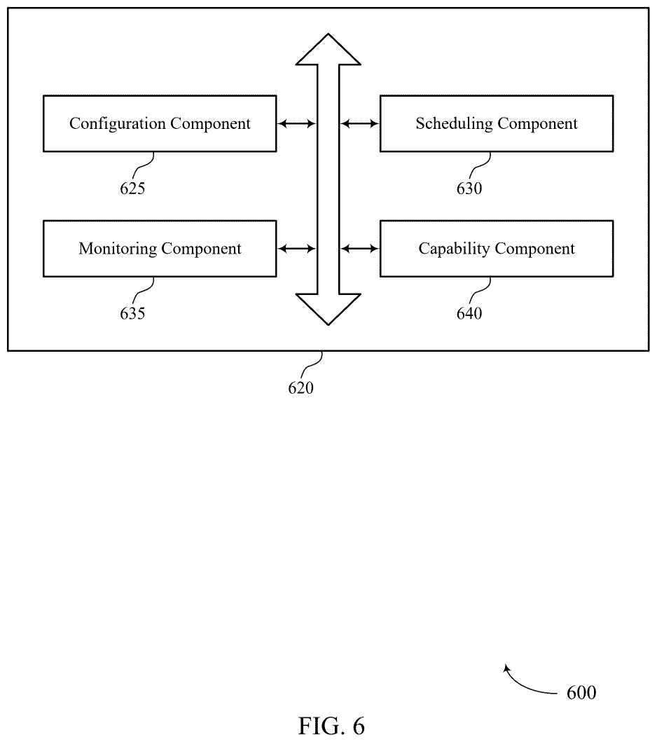

FIG. 6 shows a block diagram 600 of a communications manager 620 that supports UE behavior during downlink scheduling gaps in accordance with one or more aspects of the present disclosure. The communications manager 620 may be an example of aspects of a communications manager 420, a communications manager 520, or both, as described herein. The communications manager 620, or various components thereof, may be an example of means for performing various aspects of UE behavior during downlink scheduling gaps as described herein. For example, the communications manager 620 may include a configuration component 625, a scheduling component 630, a monitoring component 635, a capability component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receiving first configuration information indicating a first peak throughput rate associated with a first scheduling mode for the UE and a first processing timeline. In some examples, the configuration component 625 is capable of, configured to, or operable to support a means for receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions. The scheduling component 630 is capable of, configured to, or operable to support a means for receiving a control message that schedules a shared data channel transmission during a first TTI in accordance with the second scheduling mode. The monitoring component 635 is capable of, configured to, or operable to support a means for monitoring the quantity of gap TTIs following the shared data channel transmission according to a monitoring configuration, where the monitoring configuration indicates whether to monitor a downlink control channel during the quantity of gap TTIs between shared data channel transmissions.

In some examples, the quantity of gap TTIs following the shared data channel transmission includes a SBFD TTI.

In some examples, the monitoring configuration indicates to skip monitoring of one or more downlink subbands of the SBFD TTI and enables transmission of one or more uplink messages via one or more uplink subbands of the SBFD TTI.

In some examples, the monitoring configuration indicates to monitor one or more downlink subbands of the SBFD TTI, and the scheduling component 630 is capable of, configured to, or operable to support a means for receiving, via the one or more downlink subbands of the SBFD TTI, a second control message indicating scheduling information, where the scheduling information schedules downlink data on one or more TTIs that occur after a last symbol of the quantity of gap TTIs following the shared data channel transmission.

In some examples, a SBFD collision rule indicates to prioritize one of a downlink subband or an uplink subband of one or more SBFD TTIs that occur within the quantity of gap TTIs following the shared data channel transmission.

In some examples, the monitoring configuration indicates to refrain from monitoring one or more downlink subbands of one or more SBFD TTIs that occur within the quantity of gap TTIs following the shared data channel transmission and to skip transmission during one or more uplink subbands of the one or more SBFD TTIs that occur within the quantity of gap TTIs following the shared data channel transmission.

In some examples, the quantity of gap TTIs following the shared data channel transmission includes a second TTI including one or more flexible symbols. In some examples, the monitoring configuration indicates that conversion of the one or more flexible symbols of the second TTI to downlink symbols is associated with an error condition.

In some examples, the quantity of gap TTIs following the shared data channel transmission includes a second TTI including one or more flexible symbols. In some examples, the monitoring configuration indicates that transmission and reception during the second TTI is invalid.

In some examples, the quantity of gap TTIs following the shared data channel transmission includes a second TTI including one or more flexible symbols. In some examples, the monitoring configuration indicates that the one or more flexible symbols of the second TTI are uplink symbols.

In some examples, the quantity of gap TTIs following the shared data channel transmission includes a downlink TTI. In some examples, the monitoring configuration indicates to refrain from monitoring the downlink control channel during the downlink TTI.

In some examples, the quantity of gap TTIs following the shared data channel transmission includes a downlink TTI, and the scheduling component 630 is capable of, configured to, or operable to support a means for receiving, during the downlink TTI, a second control message indicating scheduling information, where the scheduling information schedules downlink data on one or more TTIs that occur after a last symbol of the quantity of gap TTIs following the shared data channel transmission.

In some examples, the configuration component 625 is capable of, configured to, or operable to support a means for receiving control signaling indicating the monitoring configuration.

In some examples, the control signaling indicating the monitoring configuration includes at least one of the control message, RRC signaling, group common DCI, or a combination thereof.

In some examples, the control signaling indicates an index value corresponding to the monitoring configuration from a set of multiple index values, each index value of the set of multiple index values indicating a respective monitoring configuration of a set of multiple monitoring configurations.

In some examples, the capability component 640 is capable of, configured to, or operable to support a means for transmitting capability information indicating a capability of the UE to support monitoring of the downlink control channel during the quantity of gap TTIs following the shared data channel transmission, where the monitoring configuration is based on the capability information.

In some cases, the configuration component 625, the scheduling component 630, the monitoring component 635, and the capability component 640 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 625, the scheduling component 630, the monitoring component 635, and the capability component 640 discussed herein.

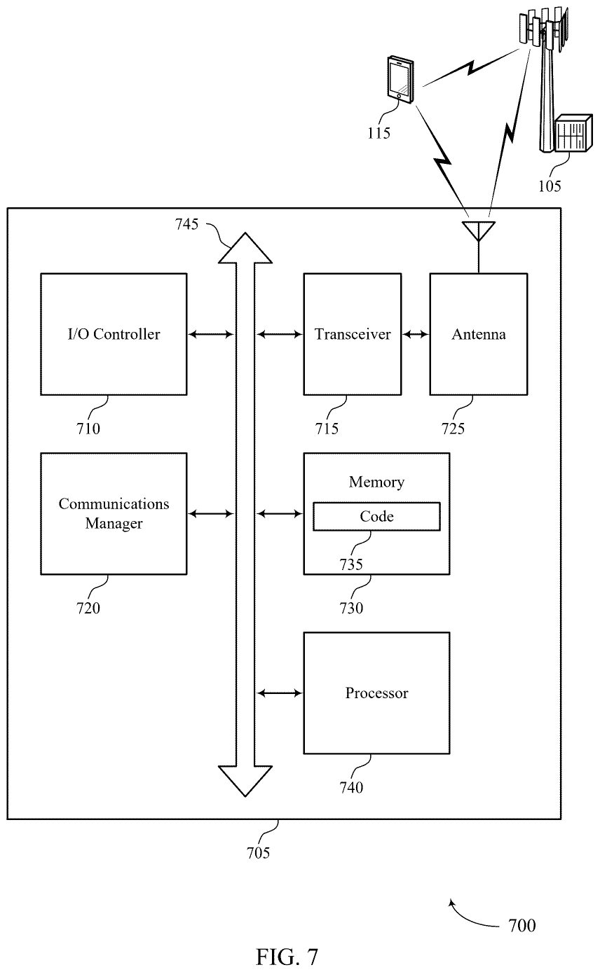

FIG. 7 shows a diagram of a system 700 including a device 705 that supports UE behavior during downlink scheduling gaps in accordance with one or more aspects of the present disclosure. The device 705 may be an example of or include components of a device 405, a device 505, or a UE 115 as described herein. The device 705 may communicate (e.g., wirelessly) with one or more other devices (e.g., network nodes 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting UE behavior during downlink scheduling gaps). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving first configuration information indicating a first peak throughput rate associated with a first scheduling mode for the UE and a first processing timeline. The communications manager 720 is capable of, configured to, or operable to support a means for receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions. The communications manager 720 is capable of, configured to, or operable to support a means for receiving a control message that schedules a shared data channel transmission during a first TTI in accordance with the second scheduling mode. The communications manager 720 is capable of, configured to, or operable to support a means for monitoring the quantity of gap TTIs following the shared data channel transmission according to a monitoring configuration, where the monitoring configuration indicates whether to monitor a downlink control channel during the quantity of gap TTIs between shared data channel transmissions.

By including or configuring the communications manager 720 in accordance with examples as described herein, the device 705 may support techniques for reduced latency, improved user experience related to reduced processing, reduced power consumption, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of UE behavior during downlink scheduling gaps as described herein, or the at least one processor 740 and the at least one memory 730 may be otherwise configured to, individually or collectively, perform or support such operations.

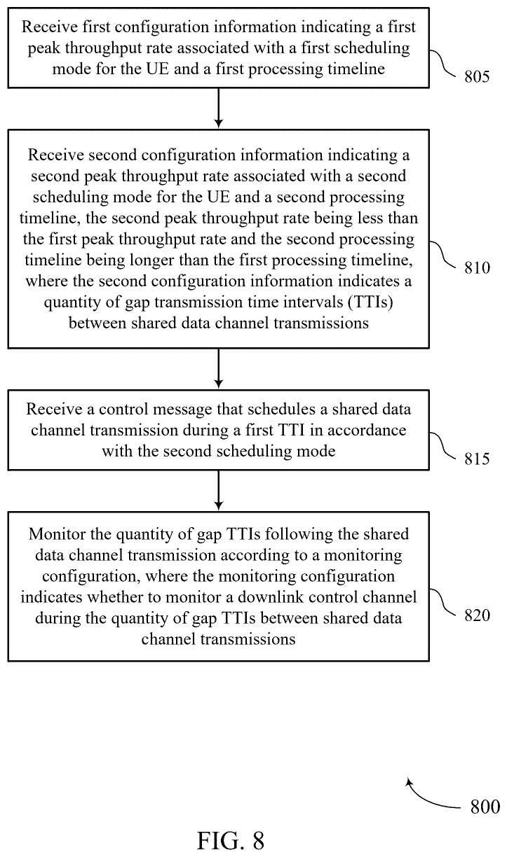

FIG. 8 shows a flowchart illustrating a method 800 that supports UE behavior during downlink scheduling gaps in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving first configuration information indicating a first peak throughput rate associated with a first scheduling mode for the UE and a first processing timeline. The operations of 805 may be performed in accordance with examples as disclosed herein. In some examples, aspects of the operations of 805 may be performed by a configuration component 625 as described with reference to FIG. 6.

At 810, the method may include receiving second configuration information indicating a second peak throughput rate associated with a second scheduling mode for the UE and a second processing timeline, the second peak throughput rate being less than the first peak throughput rate and the second processing timeline being longer than the first processing timeline, where the second configuration information indicates a quantity of gap transmission time intervals (TTIs) between shared data channel transmissions. The operations of 810 may be performed in accordance with examples as disclosed herein. In some examples, aspects of the operations of 810 may be performed by a configuration component 625 as described with reference to FIG. 6.

At 815, the method may include receiving a control message that schedules a shared data channel transmission during a first TTI in accordance with the second scheduling mode. The operations of 815 may be performed in accordance with examples as disclosed herein. In some examples, aspects of the operations of 815 may be performed by a scheduling component 630 as described with reference to FIG. 6.

At 820, the method may include monitoring the quantity of gap TTIs following the shared data channel transmission according to a monitoring configuration, where the monitoring configuration indicates whether to monitor a downlink control channel during the quantity of gap TTIs between shared data channel transmissions. The operations of 820 may be performed in accordance with examples as disclosed herein. In some examples, aspects of the operations of 820 may be performed by a monitoring component 635 as described with reference to FIG. 6.

The following provides an overview of aspects of the present disclosure:

Aspect 1: A method for wireless communications at a UE, comprising: receiving first configuration information indicating a first peak throughput rate associated with a first scheduling mode for the UE and a first processing timeline; receiving second configuration information indicating a second peak throughput rate associated with a second scheduling mode for the UE and a second processing timeline, the second peak throughput rate being less than the first peak throughput rate and the second processing timeline being longer than the first processing timeline, wherein the second configuration information indicates a quantity of gap TTIs between shared data channel transmissions; receiving a control message that schedules a shared data channel transmission during a first TTI in accordance with the second scheduling mode; and monitoring the quantity of gap TTIs following the shared data channel transmission according to a monitoring configuration, wherein the monitoring configuration indicates whether to monitor a downlink control channel during the quantity of gap TTIs between shared data channel transmissions.

Aspect 2: The method of aspect 1, wherein the quantity of gap TTIs following the shared data channel transmission comprises a SBFD TTI.

Aspect 3: The method of aspect 2, wherein the monitoring configuration indicates to skip monitoring of one or more downlink subbands of the SBFD TTI and enables transmission of one or more uplink messages via one or more uplink subbands of the SBFD TTI.

Aspect 4: The method of any of aspects 2 through 3, wherein the monitoring configuration indicates to monitor one or more downlink subbands of the SBFD TTI, the method further comprising: receiving, via the one or more downlink subbands of the SBFD TTI, a second control message indicating scheduling information, wherein the scheduling information schedules downlink data on one or more TTIs that occur after a last symbol of the quantity of gap TTIs following the shared data channel transmission.

Aspect 5: The method of any of aspects 1 through 4, wherein a SBFD collision rule indicates to prioritize one of a downlink subband or an uplink subband of one or more SBFD TTIs that occur within the quantity of gap TTIs following the shared data channel transmission.

Aspect 6: The method of any of aspects 1 through 5, wherein the monitoring configuration indicates to refrain from monitoring one or more downlink subbands of one or more SBFD TTIs that occur within the quantity of gap TTIs following the shared data channel transmission and to skip transmission during one or more uplink subbands of the one or more SBFD TTIs that occur within the quantity of gap TTIs following the shared data channel transmission.

Aspect 7: The method of any of aspects 1 through 6, wherein the quantity of gap TTIs following the shared data channel transmission comprises a second TTI comprising one or more flexible symbols, and the monitoring configuration indicates that conversion of the one or more flexible symbols of the second TTI to downlink symbols is associated with an error condition.

Aspect 8: The method of any of aspects 1 through 7, wherein the quantity of gap TTIs following the shared data channel transmission comprises a second TTI comprising one or more flexible symbols, and the monitoring configuration indicates that transmission and reception during the second TTI is invalid.

Aspect 9: The method of any of aspects 1 through 8, wherein the quantity of gap TTIs following the shared data channel transmission comprises a second TTI comprising one or more flexible symbols, and the monitoring configuration indicates that the one or more flexible symbols of the second TTI are uplink symbols.

Aspect 10: The method of any of aspects 1 through 9, wherein the quantity of gap TTIs following the shared data channel transmission comprises a downlink TTI, and the monitoring configuration indicates to refrain from monitoring the downlink control channel during the downlink TTI.

Aspect 11: The method of any of aspects 1 through 10, wherein the quantity of gap TTIs following the shared data channel transmission comprises a downlink TTI, wherein the monitoring configuration indicates to monitor the downlink control channel during the downlink TTI, the method further comprising: receiving, during the downlink TTI, a second control message indicating scheduling information, wherein the scheduling information schedules downlink data on one or more TTIs that occur after a last symbol of the quantity of gap TTIs following the shared data channel transmission.

Aspect 12: The method of any of aspects 1 through 11, further comprising: receiving control signaling indicating the monitoring configuration.

Aspect 13: The method of aspect 12, wherein the control signaling indicating the monitoring configuration comprises at least one of the control message, RRC signaling, group common DCI, or a combination thereof.

Aspect 14: The method of any of aspects 12 through 13, wherein the control signaling indicates an index value corresponding to the monitoring configuration from a plurality of index values, each index value of the plurality of index values indicating a respective monitoring configuration of a plurality of monitoring configurations.

Aspect 15: The method of any of aspects 1 through 14, further comprising: transmitting capability information indicating a capability of the UE to support monitoring of the downlink control channel during the quantity of gap TTIs following the shared data channel transmission, wherein the monitoring configuration is based at least in part on the capability information.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first configuration information indicating a first peak throughput rate associated with a first scheduling mode for the UE and a first processing timeline;
receive second configuration information indicating a second peak throughput rate associated with a second scheduling mode for the UE and a second processing timeline, the second peak throughput rate being less than the first peak throughput rate and the second processing timeline being longer than the first processing timeline, wherein the second configuration information indicates a quantity of gap transmission time intervals (TTIs) between shared data channel transmissions;
receive a control message that schedules a shared data channel transmission during a first TTI in accordance with the second scheduling mode; and
monitor the quantity of gap TTIs following the shared data channel transmission according to a monitoring configuration, wherein the monitoring configuration indicates whether to monitor a downlink control channel during the quantity of gap TTIs between shared data channel transmissions.

2. The UE of claim 1, wherein the quantity of gap TTIs following the shared data channel transmission comprises a subband full duplex TTI.

3. The UE of claim 2, wherein the monitoring configuration indicates to skip monitoring of one or more downlink subbands of the subband full duplex TTI and enables transmission of one or more uplink messages via one or more uplink subbands of the subband full duplex TTI.

4. The UE of claim 2, wherein the monitoring configuration indicates to monitor one or more downlink subbands of the subband full duplex TTI, and the one or more processors are individually or collectively further operable to execute the code to cause the UE to:
receive, via the one or more downlink subbands of the subband full duplex TTI, a second control message indicating scheduling information, wherein the scheduling information schedules downlink data on one or more TTIs that occur after a last symbol of the quantity of gap TTIs following the shared data channel transmission.

5. The UE of claim 1, wherein a subband full duplex collision rule indicates to prioritize one of a downlink subband or an uplink subband of one or more subband full duplex TTIs that occur within the quantity of gap TTIs following the shared data channel transmission.

6. The UE of claim 1, wherein the monitoring configuration indicates to refrain from monitoring one or more downlink subbands of one or more subband full duplex TTIs that occur within the quantity of gap TTIs following the shared data channel transmission and to skip transmission during one or more uplink subbands of the one or more subband full duplex TTIs that occur within the quantity of gap TTIs following the shared data channel transmission.

7. The UE of claim 1, wherein:
the quantity of gap TTIs following the shared data channel transmission comprises a second TTI comprising one or more flexible symbols, and
the monitoring configuration indicates that conversion of the one or more flexible symbols of the second TTI to downlink symbols is associated with an error condition.

8. The UE of claim 1, wherein:
the quantity of gap TTIs following the shared data channel transmission comprises a second TTI comprising one or more flexible symbols, and
the monitoring configuration indicates that transmission and reception during the second TTI is invalid.

9. The UE of claim 1, wherein:
the quantity of gap TTIs following the shared data channel transmission comprises a second TTI comprising one or more flexible symbols, and
the monitoring configuration indicates that the one or more flexible symbols of the second TTI are uplink symbols.

10. The UE of claim 1, wherein:
the quantity of gap TTIs following the shared data channel transmission comprises a downlink TTI, and
the monitoring configuration indicates to refrain from monitoring the downlink control channel during the downlink TTI.

11. The UE of claim 1, wherein the quantity of gap TTIs following the shared data channel transmission comprises a downlink TTI, and the one or more processors are individually or collectively further operable to execute the code to cause the UE to:
receive, during the downlink TTI, a second control message indicating scheduling information, wherein the scheduling information schedules downlink data on one or more TTIs that occur after a last symbol of the quantity of gap TTIs following the shared data channel transmission.

12. The UE of claim 1, wherein the one or more processors are individually or collectively further operable to execute the code to cause the UE to:
receive control signaling indicating the monitoring configuration.

13. The UE of claim 12, wherein the control signaling indicating the monitoring configuration comprises at least one of the control message, radio resource control (RRC) signaling, group common downlink control information, or a combination thereof.

14. The UE of claim 12, wherein the control signaling indicates an index value corresponding to the monitoring configuration from a plurality of index values, each index value of the plurality of index values indicating a respective monitoring configuration of a plurality of monitoring configurations.

15. The UE of claim 1, wherein the one or more processors are individually or collectively further operable to execute the code to cause the UE to:
transmit capability information indicating a capability of the UE to support monitoring of the downlink control channel during the quantity of gap TTIs following the shared data channel transmission, wherein the monitoring configuration is based at least in part on the capability information.

16. A method for wireless communications at a user equipment (UE), comprising:
receiving first configuration information indicating a first peak throughput rate associated with a first scheduling mode for the UE and a first processing timeline;
receiving second configuration information indicating a second peak throughput rate associated with a second scheduling mode for the UE and a second processing timeline, the second peak throughput rate being less than the first peak throughput rate and the second processing timeline being longer than the first processing timeline, wherein the second configuration information indicates a quantity of gap transmission time intervals (TTIs) between shared data channel transmissions;
receiving a control message that schedules a shared data channel transmission during a first TTI in accordance with the second scheduling mode; and
monitoring the quantity of gap TTIs following the shared data channel transmission according to a monitoring configuration, wherein the monitoring configuration indicates whether to monitor a downlink control channel during the quantity of gap TTIs between shared data channel transmissions.

17. The method of claim 16, wherein the quantity of gap TTIs following the shared data channel transmission comprises a subband full duplex TTI.

18. The method of claim 17, wherein the monitoring configuration indicates to skip monitoring of one or more downlink subbands of the subband full duplex TTI and enables transmission of one or more uplink messages via one or more uplink subbands of the subband full duplex TTI.

19. The method of claim 17, wherein the monitoring configuration indicates to monitor one or more downlink subbands of the subband full duplex TTI, the method further comprising:
receiving, via the one or more downlink subbands of the subband full duplex TTI, a second control message indicating scheduling information, wherein the scheduling information schedules downlink data on one or more TTIs that occur after a last symbol of the quantity of gap TTIs following the shared data channel transmission.

20. A non-transitory computer-readable medium storing code for wireless communications at a user equipment (UE), the code comprising instructions executable by one or more processors to:
receive first configuration information indicating a first peak throughput rate associated with a first scheduling mode for the UE and a first processing timeline;
receive second configuration information indicating a second peak throughput rate associated with a second scheduling mode for the UE and a second processing timeline, the second peak throughput rate being less than the first peak throughput rate and the second processing timeline being longer than the first processing timeline, wherein the second configuration information indicates a quantity of gap transmission time intervals (TTIs) between shared data channel transmissions;
receive a control message that schedules a shared data channel transmission during a first TTI in accordance with the second scheduling mode; and
monitor the quantity of gap TTIs following the shared data channel transmission according to a monitoring configuration, wherein the monitoring configuration indicates whether to monitor a downlink control channel during the quantity of gap TTIs between shared data channel transmissions.
